(19) United States
(12) Patent Application Publication
(10) Pub. No.: US 2005/0086173 A1
(43) Pub. Date: Apr. 21, 2005

(54) Auto-regulated electronic license key mechanism

(76) Inventor: Sham R. Kalwit, Cupertino, CA (US)

Correspondence Address: Sham Kalwit, 20990, Valley Green Drive, #698, Cupertino, CA, 95014, US

(21) Appl. No.: 10/690,040

(22) Filed: Oct. 20, 2003

(51) Int. Cl. H04L 9/00

(52) U.S. Cl. 705/59

(57) ABSTRACT

Auto-regulated Electronic License Key Mechanism utilizes personal verifiable information, such as Credit Card information, Social Security Number etc, to generate license keys such that the same information is required by the authenticating part of the said mechanism embedded in the associated software for which the license is generated. One module is implemented as a stand-alone program or with a web interface and provides license key generation for purchasing with human interaction or on the web. The other module is embedded in the installer or the software program for which license key is generated and authenticates the license key based on the personal information provided. This mechanism provides a built in barrier to illegal use of the said software due to the fact that consumers always guard their personal information.

### CROSS REFERENCES TO RELATED APPLICATIONS

Not Applicable

### FEDERALLY SPONSORED RESEARCH AND DEVELOPMENT

Not Applicable

### LISTING OF PROGRAM

Provided on the accompanying CD in the folders named Admin and AdminLic.

### BACKGROUND OF INVENTION

### Introduction, Prior Art, Advantages of Invention

Piracy of intellectual property is almost as old as the notion of intellectual property itself. And various people and corporations have attempted to curb piracy with various innovative ideas to differing degrees. Various schemes have been devised to specifically protecting software products. These include various ideas from protecting the physical media to running the software with special hardware to discretely saving information in some persistent form to allow limited runs of the software to many other schemes, which may not be very relevant in current times and prevalent technology scenario.

Most of the software protection ideas have been rendered useless by the technological change where the Internet has become the prevalent medium of distribution of software. Since the pre-Internet time and to some extent, even today, most of the off-the-shelf software packages and programs continue to use license keys to establish authenticity and accountability: authenticity by way of ensuring that the software would not run without the provided key and accountability because a key can be tied to the customer who purchases it.

Software piracy losses were estimated at $11.75 billion in 2000 and 10.97 billion in 2001. An effective solution to this problem is required to sustain US software industry and make it more efficient.

This invention establishes a simple yet efficient mechanism to effectively curb unintended proliferation of license keys. In its simplest form or combined with other and/or existing licensing schemes that product companies have, this invention can be a very effective way to protect software companies investment in to research and development that is required to introduce and sell a software product.

There are various methods and patents in the area of license key generation and management that address the diverse needs of this area. Some of the objectives of a license key management system is that it must protect the intellectual property right of the individual or company creating and/or marketing products involving that intellectual property.

U.S. Pat. No. 5,666,411 (System for computer software protection) discloses a method to protect software from unauthorized use and duplication. However it is dependent upon enciphering each program for individual machines and essentially creating a unique program for every license and therefore is neither scalable nor suitable for media like the Internet.

U.S. Pat. No. 6,460,140 (System for controlling the use of licensed software) discusses use of a registration database to allow unlocking use of software by the user upon presenting the registration key. This approach suffers from several disadvantages. One of the first such inconveniences to the users is that the user needs to have Internet connectivity in order to start using the system. While this approach benefits the Vendor in that the vendor can obtain and maintain User information, it does not benefit the user in any way. Further it is still possible to for the user to provide the obtained key to unlock the software for another installation and proliferate illegal use of software. Therefore this approach does not help the software vendor in effectively curbing software piracy.

U.S. Pat. No. 6,574,612 discusses a license management system that permits concurrent use of a predetermined number of copies of a software program over a network. While it effectively addresses the issue of flexibility of license administration, it is not meant to solve or even attempt to the problem of illegal license proliferation.

U.S. Pat. No. 5,671,412 proposes ways of managing component licenses in a suite made up of components to effectively deal with suite license management. While it facilitates license administration, it does not address the issue of illegal license proliferation.

U.S. Pat. No. 5,553,143 titled “Method and apparatus for electronic licensing” defines a method of administering licenses addressing a variety of areas concerning license management. It addresses various media (CD, Network distribution etc) used in distribution of software and also addresses enforcement of licenses and is peripheral to the issue of unintended and/or illegal license proliferation.

U.S. Pat. No. 6,334,189 discusses 3 layered approaches involving encryption/decryption of user data and leveraging pseudo code for copy protection wherein it becomes difficult for anyone trying to overcome the protection mechanism to decrypt the user information resulting in partial functioning of the said software thereby making it more difficult to identify and disable the copy protection mechanism. While it provides a mechanism to avoid illegal proliferation of license keys, it is based on the complexity of decrypting the license information and does not have a built in mechanism to persuade the customer herself from offering the license keys to someone else. Additionally it presupposes use of ESD (Electronic Security Device) which are external appendages required to be attached to a computer for normal operation of the software and such devices are highly out of fashion and not preferred by common customers. Use of such devices is expensive and not generally liked by customers.

U.S. Pat. No. 4,817,140 (Software protection system using a single-key cryptosystem, a hardware-based authorization system and a secure coprocessor) discusses an effective mechanism for copy protection but is dependent on use of a coprocessor as well as use of an external device to generate a token. While effective 10-12 years ago, such mechanisms are not scalable and can not be effectively employed, for example, to sell on the internet.

U.S. Pat. No. 4,644,493 (Implementing a shared higher level of privilege on personal computers for copy protection of software) discusses use of “uncopyable physical media” and is unsuitable where distribution mechanism is other than the magnetic media (such as Internet download of a software).

U.S. Pat. No. 6,189,146 (System and method for software licensing) proposes a licensing system that uses a license server and public key infrastructure to encrypt license keys and establish ownership of software. It also uses a master database to hold client information. While it effectively proposes a solution for license key management, the method is not suitable for license distribution in absence of a server to enforce licenses and the rest of the described infrastructure.

U.S. Pat. No. 4,306,289 (Digital computer having code conversion apparatus for an encrypted program) describes a modified computer processor architecture to allow a scrambled program to run properly by decrypting an instruction just before it enters a CPU's registers. This method is highly unsuitable to protect any unintended duplication because of the non-standard hardware required as well as failure to stop making copies of the “scrambled” code. The only way this invention can stop unintended proliferation of software is by requiring special hardware. Current generation of end users is extremely wary of any such solutions. Additionally, this is highly un-scalable solution to the said problem.

The present invention is different and effective in that it is very simple, does not require specialized disk or specialized processors and is not language dependent. Further it can easily be adapted to the software distribution method including the Internet.

The objects and advantages of this invention are
1. to provide increased security for the consumer. A software owned by a consumer can not be stolen or copied without his/her consent.
2. to decrease likelihood of software piracy. Using consumers personal information to authenticate eliminates the likelihood that a consumer will casually give away the license.
3. to provide a simple and effective mechanism that can be implemented on a variety of hardware platforms and in a variety of software languages.
4. to provide a licensing method suitable for a variety of mediums, including Point Of Sale person to person transactions as well as automated web based transactions.

### SUMMARY

This invention uses consumers' personal verifiable information like credit card number to generate a license key that can be given away with purchase of software and requires that the same information be presented to activate the license key. This invention works by way of using one-way hash to arrive at a sequence of letters and/or digits that is embedded in the license key. The software being sold or its installer program contains the code used to generate the license key such that it prompts the user to provide the information used at the time of purchase of software so that it can internally generate a key for comparison and thus authenticate and continue or reject the process of installing or using the software.

### DESCRIPTION OF DRAWINGS

Not Applicable

### DETAILED DESCRIPTION OF INVENTION

This invention relates to the field of software and uses personal verifiable information like credit card number, social security numbers etc. and using one-way hash, encrypts it the license key such that the same information is required to activate the key again by the installer program or the actual software program being sold. It makes use of unwillingness on part of purchaser to distribute his/her personal information that is required to activate the license key. Since the personal information is stored in one-way hash, it can not be retrieved and is therefore safe thereby protecting the consumer and also eliminates or limits the unintended proliferation of license keys and protects the software vendor. It helps protect the consumer by disallowing use or installation of the purchased software without their consent. It also protects the software vendor by discouraging a consumer to give away the license to someone else since his/her personal information also is required in order for the software to install and/or operate. It can save huge amounts of money for the US software industry and help protect their intellectual property rights.

The invention is described in following sections . . .
1. How to generate license keys
2. How to validate and authenticate the license keys.
   The Following Algorithm Describes in Detail the Process of Generating the License Key

Implementation of the invented mechanism can be done in a variety of ways. Following is an example of such an implementation. The following description does not preclude the invention to be implemented in other ways. Various factors in this scheme can be varied in such a way so that millions of unique combinations for the key can be generated. The license keys are always used in conjunction with the user information and the possibility of a license key being opened by a different piece of information is minimal and statistically measurable.

The following steps describe how a license can be generated. The example uses a credit card number as the input, however any other character stream can be used in its place.

A. Step 1:
a. The input number is 8098-7712-6396-4197
b. Total of ordinal values of each of the digit is as follows: 56+55+54+52+48+57+56+55+49+50+51+57+54+49+57+55=927
c. Get the new base based on the total of first digits of all 4 digit subsections (they are 8,7,6 and 4): 56+55+54+52=217
d. The result of the one way function are: 927=217*4+59: (4 and 59)
e. Store that as XX-YYY number (4 and 59 will become 04059).

B. Step 2:
a. Multiply the numbers to get base for random # generator
b. If one number is 0, use the other one as base.

C. Step 3:
a. Get 20 more random numbers N numbers apart between 0 and 35, where N is determined based on some combination of values coming from the input information provided by the user.

D. Step 4:
a. If the number is less than 10, use it as a digit. (0 to 9)
b. For numbers 10 and onwards, get a letter (55+number).

E. Step 5:
a. Build the license key, following some predetermined scheme. One example is to use the 5 numbers generated in Step 1-f as first tokens in the license key. The other scheme is to use each of them as the first token in the license key.

F. Step 6:
a. Final outcome can be as follows:
b. A1A2A3A4A5-B1B2B3B4B5-C 1 C2C3C4C5-D 1 D2D3D4D5-E 1 E2E3E4E5 where each letter and number combination identifies an alpha numeric placeholder.
c. Assume the random number generator gave us the following 20 numbers 11,1,10,2,9,23,28,4,11,10,6,7,20,28,31,1,10,20,2,9.
d. This would result in the following key 04059-B1A29-MR4BA-67JRU-1AJ29 where the first 5 digits came from the credit card hash value and remaining from the random number generator where base was specified by a combination of same hash value. Therefore using the algorithm provided above credit card number 8098-7712-6396-4197 is tied to the key 04059-B1A29-MR4BA-67JRU-1AJ29 uniquely to a certain degree. The degree of uniqueness required can be fully customized by making variations in the hash value generation scheme. These schemes can vary in almost unlimited way and can include aggregation of digits as described above or replacement based on predefined arrays or any such scheme giving a hash value or a set of hash values.

Each of these steps can be modified and customized depending upon the uniqueness of the desired hash value. Such algorithms are well known and often used for other purposes in computer science. The ultimate target of this set of steps is to generate a license key uniquely based on the provided credit card number.

The Following Process Describes in Detail the Process of Using the License Key

Following process assumes an automatic web-based transaction.
1. Customer selects the software product license to buy and presents his/her credit card
2. Purchasing software verifies the card with the credit card company electronically and requests authorization
3. If the card is authorized, the card number is passed to the module for generating license key.
4. The license key is given to the customer on the web or by email
5. Customer starts the install program. The Install program prompts the customer to provide the license key along with the credit card used to purchase it
6. The license program internally generates the license key using the same algorithm used by the module that generated the license key and matches that with the one provided by the customer.
7. If the license key is any different from the one given to the customer in the first place, it will not match with the one generated by the installer and authentication will fail. Similarly if the credit card number is any different than the one used for purchasing, an entirely different key may be generated and authentication will fail again. Authentication will work only if credit card matches the license key.
8. If the match is found, installation will continue otherwise it will terminate or ask to re-enter the information.

Following process assumes a manual transaction involving a human in the selling process
1. Customer selects the software product license to buy and presents his/her credit card
2. The seller requests authorization for the card. Upon authorization, he/she inputs the card number in a special program that has the license key generation module in it.
3. The program generates the license key
4. License key is given to the user in a print form.
5. Customer starts the install program. The Install program prompts the customer to provide the license key along with the credit card used to purchase it
6. The license program internally generates the license key using the same algorithm used by the module that generated the license key and matches that with the one provided by the customer.
7. If the license key is any different from the one given to the customer in the first place, it will not match with the one generated by the installer and authentication will fail. Similarly if the credit card number is any different than the one used for purchasing, an entirely different key may be generated and authentication will fail again. Authentication will work only if credit card matches the license key.
8. If the match is found, installation will continue otherwise it will terminate or ask to re-enter the information.
   Computer Program:

A Visual Basic 6.0 based program source code is provided on the accompanying CD in the folder named “Admin”. Another folder named “AdminLic” is also provided that contains source code for a DLL that can be compiled using Visual C++ version 6.0. When compiled, this program generates keys based on a string of digits and can be easily adapted to use on-line credit card verification as an additional step and demonstrates the essential working of the said invention. Disc labeled “Copy I” contains 2 folders named “Admin” and “AdminLic”. Folder named Admin contains Visual Basic Source code of an Application with User Interface that uses a Dynamic Link Library that can be built out of source code provided in folder named “AdminLic”. Disc labeled Copy 2 is an identical copy of Disc labeled Copy 1. The computer program provided on the CD is hereby included and presented as a part of specification for the said patent. An accompanying transmittal letter details contents of both CDs and describes steps to compile the source code.

1. A method of restricting license key(s) distribution to intended user of a software product, comprising
a. a method of generating keys, which is based upon a verifiable personal piece of information, like Social Security Number or Credit Card Number of the said user
b. a mechanism that generates key/s to be distributed to the said user for the said software, such that the said mechanism generates keys utilizing the said verifiable personal information, using a transformation algorithm that suitably converts the said verifiable information into a license key
c. a similar mechanism as described in (b) used for authentication, such that
1. it is embedded in the said software or an install software program for the said software
2. it prompts for the same verifiable personal piece of information that was provided while purchasing the license by the said user, and
3. it internally generates a key based on the provided information to match with the said key obtained by the said user at the time of purchase and provided for authentication when prompted by the said installer program or the said software.
whereby, the said license key can only be authenticated using the said verifiable information used to generate it.
